(19) United States
(12) Patent Application Publication
(10) Pub. No.: US 2020/0131698 A1
(43) Pub. Date: Apr. 30, 2020

(54) Sublimation-Transer Ink Jet Ink Composition And Manufacturing Method For Dyed Article

(71) Applicant: Seiko Epson Corporation, Tokyo (JP)

(72) Inventor: Hiroshi FUKUMOTO, Shiojiri (JP)

(21) Appl. No.: 16/668,100

(22) Filed: Oct. 30, 2019

(30) Foreign Application Priority Data
Oct. 31, 2018 (JP) 2018-205283

(51) Int. Cl. D06P 5/28; D06P 5/30; C09D 11/328

(52) U.S. Cl. CPC D06P 5/006; C09D 11/328; D06P 5/30

(57) ABSTRACT

A sublimation-transfer ink jet ink composition contains C.I. Disperse Blue 359 and C.I. Disperse Blue 60.

The present application is based on, and claims priority from, JP Application Serial Number 2018-205283, filed Oct. 31, 2018, the disclosure of which is hereby incorporated by reference herein in its entirety.

### BACKGROUND

### 1. Technical Field

The present disclosure relates to a sublimation-transfer ink jet ink composition and to a manufacturing method for a dyed article.

### 2. Related Art

An ink jet recording method enables recording of high-resolution images by using a relatively simple apparatus and thus has been developing rapidly in many fields. Under such circumstances, various studies have been conducted to obtain high-quality recorded articles in a further stable manner.

JP-A-2016-190933 discloses that a magenta ink composition of combined fluorescent and non-fluorescent dyes exhibits excellent balance between chroma and coloring properties.

However, JP-A-2016-190933 does not disclose studies to obtain a cyan ink excellent in both hue and coloring properties. Accordingly, there is a need for such a cyan ink.

### SUMMARY

The present inventors conducted intensive studies to meet the above-mentioned need. As a result, the present inventors found that a sublimation-transfer ink jet ink composition of combined two specific dyes can meet the above-mentioned need, thereby accomplishing the present disclosure.

Specifically, the present disclosure is as follows. A sublimation-transfer ink jet ink composition contains C.I. Disperse Blue 359 and C.I. Disperse Blue 60. A mass ratio of the content of C.I. Disperse Blue 60 to the content of C.I. Disperse Blue 359 may be 0.2 to 5.0. The sublimation-transfer ink jet ink composition may further contain one or more dispersants, where the dispersants may include sodium naphthalenesulfonate-formaldehyde condensate. The sublimation-transfer ink jet ink composition may further contain one or more dispersants, where the dispersants may include a resin. The resin may be a styrene-acrylic resin. The content of the dispersants may be 3 to 8% by mass based on the total sublimation-transfer ink jet ink composition. A total content of C.I. Disperse Blue 359 and C.I. Disperse Blue 60 may be 3 to 8% by mass based on the total sublimation-transfer ink jet ink composition. A manufacturing method for a dyed article includes: discharging a sublimation-transfer ink jet ink composition from a recording head to attach the ink composition to an intermediate transfer medium; and transferring the sublimation-transfer ink jet ink composition attached to the intermediate transfer medium to a fabric, thereby obtaining the dyed article.

### DESCRIPTION OF EXEMPLARY EMBODIMENTS

Hereinafter, embodiments of the present disclosure (hereinafter, referred to as the “present embodiments”) will be described in detail. The present disclosure, however, is not limited to these embodiments, and various modifications are possible without departing from the gist of the present disclosure.

### Sublimation-Transfer Ink Jet Ink Compositions

The sublimation-transfer ink jet ink composition of the present embodiment contains C.I. Disperse Blue 359 and C.I. Disperse Blue 60 as disperse dyes. Hereinafter, the referred to as the ink composition in some cases. In the ink jet ink composition of the present embodiment, a cyan ink excellent in balance between hue and coloring properties can be obtained by incorporating C.I. Disperse Blue 359 and C.I. Disperse Blue 60. The present inventors surprisingly found that a cyan ink excellent in balance between hue and coloring properties can be obtained by combining C.I. Disperse Blue 359, which is inferior in weatherability and in hue as a cyan ink due to strong reddish tinge, with C.I. Disperse Blue 60, which is inferior in coloring properties. This is presumably because, but is not limited to, due to excellent coloring properties of C.I. Disperse Blue 359 and excellent weatherability of C.I. Disperse Blue 60, poor performance of either of these disperse dyes is offset by excellent performance of the other disperse dye. Moreover, the present inventors surprisingly found that clogging resistance tends to be enhanced by combining C.I. Disperse Blue 359, which is rather inferior in clogging resistance, with C.I. Disperse Blue 60. This is presumably because, but is not limited to, that C.I. Disperse Blue 60 having an anthraquinone skeleton suppresses recrystallization of C.I. Disperse Blue 359 similarly having an anthraquinone skeleton.

The ink composition contains C.I. Disperse Blue 359 and C.I. Disperse Blue 60 as disperse dyes. Herein, a “disperse dye” refers to a dye having properties in which the dye sublimes upon heating. Here, the disperse dyes may or may not include other dyes unless the effects of the present disclosure are impaired.

The total content of C.I. Disperse Blue 359 and C.I. Disperse Blue 60 is preferably 3 to 8% by mass based on the total ink composition. When the total content falls within the above-mentioned range, hue and coloring properties tend to become further excellent. From the same viewpoint, the total content is more preferably 3.5 to 7% by mass and further preferably 4 to 6% by mass.

A mass ratio of the content of C.I. Disperse Blue 60 to the content of C.I. Disperse Blue 359 is preferably 0.2 to 5.0. When the mass ratio is 0.2 or more, weatherability and hue tend to become further excellent. Meanwhile, when the mass ratio is 5.0 or less, coloring properties tend to become further excellent. From the same viewpoints, the mass ratio is more preferably 0.3 to 3.0 and further preferably 0.5 to 2.0.

### Dispersants

The ink composition preferably contains a dispersant. By incorporating a dispersant, the ink composition is excellent in dispersibility of disperse dyes and thus excellent in clogging resistance performance. Exemplary dispersants include sodium naphthalenesulfonate-formaldehyde condensate and a resin. The dispersant may be used alone or in combination.

The dispersants preferably include sodium naphthalenesulfonate-formaldehyde condensate in view of further excellent clogging resistance. Sodium naphthalenesulfonate-formaldehyde condensate is a compound or its salt obtained by condensing, with formaldehyde, a sulfonated compound having a naphthalene ring within the molecule.

The dispersants preferably include a resin in view of further reduced odor. Examples of the resin include urethane resins, styrene-acrylic resins, acrylic resins, fluorene-based resins, polyolefin resins, rosin-modified resins, terpene resins, polyester resins, polyamide resins, epoxy resins, vinyl chloride-based resins, vinyl chloride-vinyl acetate copolymer, and ethylene/vinyl acetate-based resins. Among these resins, in view of further excellent clogging resistance, urethane resins or styrene-acrylic resins are preferable, and styrene-acrylic resins are more preferable.

The urethane resins are not particularly limited provided that resins have urethane linkages within the molecule. In view of storage stability of the ink jet ink composition, the urethane resins preferably have an anionic functional group and more preferably have one or more types of anionic functional groups selected from the group consisting of a carboxy group, a sulfo group, and a hydroxy group.

Exemplary urethane resins include polyether-urethane resins having ether linkages in the main chains in addition to urethane linkages, polyester-urethane resins having ester linkages in the main chains in addition to urethane linkages, and polycarbonate-urethane resins having carbonate linkages in the main chains in addition to urethane linkages. These urethane resins are used alone or in combination.

The urethane resins may be commercial products. Exemplary commercial products include “Takelac W 6110” from Mitsui Chemicals, Inc., “Acrit WBR-022U” from Taisei Fine Chemical Co., Ltd., “Permarin UX-368T” from Sanyo Chemical Industries, Ltd., “Uprene UXA-307” from Sanyo Chemical Industries, Ltd., “Ucoat UWS-145” from Sanyo Chemical Industries, Ltd., and “Solsperse 47000” from Lubrizol Corporation (all the commercial products are trade names).

The styrene-acrylic resins are not particularly limited, and examples include styrene-acrylic acid copolymer, styrene-methacrylic acid copolymer, styrene-methacrylic acid-acrylic ester copolymers, styrene-α-methylstyrene-acrylic acid copolymer, and styrene-α-methylstyrene-acrylic acid-acrylic ester copolymers. These copolymers may be in any form of a random copolymer, a block copolymer, an alternating copolymer, and a graft copolymer. Further, the styrene-acrylic resins may be commercial products, and exemplary commercial products include “Joncryl 67” from BASF Japan Ltd. and “Solsperse 43000” from Lubrizol Corporation (both commercial products are trade names).

The content of the dispersants is preferably 3 to 8% by mass based on the total ink composition. When the content of dispersants falls within the above-mentioned range, the hue, coloring properties, and clogging resistance of the ink composition can be further enhanced in a well-balanced manner. From the same viewpoint, the content of dispersants is more preferably 3.5 to 7% by mass and further preferably 4 to 6% by mass.

The ink composition contains water. Water is not particularly limited, and examples include pure water, such as deionized water, ultrafiltration water, reverse osmosis water, and distilled water; as well as ultrapure water.

The content of water may be 30 to 80% by mass based on the total ink composition.

### Water-Soluble Organic Solvents

The ink composition may contain a water-soluble organic solvent. By incorporating a water-soluble organic solvent, the ink composition tends to exhibit further excellent clogging resistance through enhanced moisture retention and resolubility of disperse dyes. Exemplary water-soluble organic solvents include polyol compounds that have 2 or more and 6 or less carbon atoms within the molecule and optionally have one ether linkage within the molecule. Specific examples of the polyol compounds include diethylene glycol, triethylene glycol, polyethylene glycol, propylene glycol, dipropylene glycol, tripropylene glycol, polypropylene glycol, polyoxyethylene-polyoxypropylene glycol, methyl triglycol, butyl triglycol (triethylene glycol monobutyl ether), butyl diglycol (diethylene glycol monobutyl ether), dipropylene glycol monopropyl ether, glycerol, and alkanediols. Exemplary alkanediols include 1,2-hexanediol, 1,2-heptanediol, 1,3-propanediol, 1,2-butanediol, 1,3-butanediol, 1,4-butanediol, 2,3-butanediol, 3-methyl-1,3-butanediol, 1,2-pentanediol, 1,5-pentanediol, 1,6-hexanediol, 2-methyl-2,4-pentanediol, and 3-methyl-1,5-pentanediol. These water-soluble organic solvents may be used alone or in combination.

The content of water-soluble organic solvents may be 20 to 30% by mass based on the total ink composition.

### Surfactants

The surfactants of the present embodiment are not particularly limited and examples include acetylenic glycol surfactants, fluorosurfactants, and silicone surfactants. Among these surfactants, silicone surfactants are preferable from a viewpoint of exerting the effects of the present disclosure further effectively and reliably.

The acetylenic glycol surfactants are not particularly limited but are preferably one or more selected from the group consisting of 2,4,7,9-tetramethyl-5-decyne-4,7-diol, an alkylene oxide adduct of 2,4,7,9-tetramethyl-5-decyne-4,7-diol, 2,4-dimethyl-5-decyne-4-ol, and an alkylene oxide adduct of 2,4-dimethyl-5-decyne-4-ol, for example. Commercial products of the acetylenic glycol surfactants are not particularly limited, and examples include Olfine 104 series and Olfine E series, such as Olfine E1010 (products from Air Products and Chemicals, Inc.), Surfynol 465, and Surfynol 61 (products from Nissin Chemical Industry Co., Ltd.). The acetylenic glycol surfactants may be used alone or in combination.

The fluorosurfactants are not particularly limited and examples include perfluoroalkylsulfonate salts, perfluoroalkylcarboxylate salts, perfluoroalkyl phosphates, a perfluoroalkyl-containing polyethylene oxide, perfluoroalkyl betaines, and perfluoroalkylamine oxide compounds. Commercial products of the fluorosurfactants are not particularly limited, and examples include S-144, S-145 (products from Asahi Glass Co., Ltd.); FC-170C, FC-430, Fluorad-FC 4430 (products from Sumitomo 3M Limited); FSO, FSO-100, FSN, FSN-100, FS-300 (products from DuPont); and FT-250 and 251 (products from Neos Company Limited). These fluorosurfactants may be used alone or in combination.

The silicone surfactants are not particularly limited, and examples include polysiloxane compounds and polyether-modified organosiloxanes. Commercial products of the silicone surfactants are not particularly limited, and examples include BYK-306, BYK-307, BYK-333, BYK-341, BYK-345, BYK-346, BYK-347, BYK-348, and BYK-349 (products from BYK Japan KK); KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (products from Shin-Etsu Chemical Co., Ltd.). These silicone surfactants may be used alone or in combination.

The content of surfactants may be 0.5 to 1.5% by mass based on the total ink composition.

### Uses

The ink composition is suitably applicable to a dyeing method for fabrics and the like utilizing sublimation transfer. Herein, examples of the dyeing method utilizing sublimation transfer include the following method. The method includes ink jet printing on a sheet transfer medium, such as paper, by using the ink jet ink composition of the present embodiment, followed by sublimation transfer through heating of the transfer medium placed on a recording medium, such as a fabric.

### Manufacturing Method for Dyed Articles

A manufacturing method for a dyed article of the present embodiment, which is a dyeing method utilizing sublimation transfer, includes: discharging the ink composition of the present embodiment from a recording head to attach the ink composition to an intermediate transfer medium; and transferring the ink composition attached to the intermediate transfer medium to a fabric, thereby obtaining the dyed article. Through this procedure, it is possible to provide a manufacturing method for a dyed article that enables productive manufacture of a dyed article. Hereinafter, each step will be described.

### Discharge Step

In this step, the ink composition of the present embodiment is applied to a recording surface of an intermediate transfer medium, for example, by the ink jet method. The discharge of the ink composition by the ink jet method can be performed by using a droplet discharge apparatus, such as an ink jet recording apparatus described hereinafter.

As a droplet discharge mode, a piezo mode, a mode of discharging an ink composition by bubbles generated upon heating of the ink composition, or the like is employed. Among these droplet discharge modes, a piezo mode is preferable in view of resistance to deterioration of an ink composition and the like.

Exemplary intermediate transfer media include paper, such as plain paper, and recording media having ink receiving layers. Among these intermediate transfer media, paper having an ink receiving layer containing inorganic particles, such as silica, is preferable. By using such paper, it is possible to obtain an intermediate recorded article in which bleeding or the like on a recorded side is suppressed during a drying process of an ink composition that has been applied to an intermediate transfer medium. In addition, since such a medium tends to retain disperse dyes on the surface of the recorded side, sublimation of the disperse dyes can be more efficiently performed in the later transfer step.

In this step, a plurality of ink compositions may be used. Consequently, it is possible to further widen the color gamut to be expressed, for example. Among a plurality of such ink compositions, one or two or more ink compositions may be the ink compositions of the present embodiment. From a viewpoint of exerting the effects of the present disclosure more effectively and reliably, all of the above-mentioned ink compositions are preferably the ink compositions of the present embodiment.

### Transfer Step

Subsequently, the recorded side of the intermediate transfer medium, to which the ink composition has been applied, is heated, for example, while being set facing an article to be dyed, thereby transferring constituent disperse dyes of the ink composition to the article to be dyed. As a result, a dyed article of a fabric or the like, as an article to be dyed, can be obtained.

This step may be performed by heating the intermediate transfer medium to which the ink composition has been applied while being set facing an article to be dyed. This step is more preferably performed by heating the intermediate transfer medium while being stuck on an article to be dyed. Consequently, further clear images can be recorded on recording media, for example.

As such articles to be dyed, sheet-shape articles, such as resin films and fabrics including hydrophobic fiber fabrics, are suitably used, for example. Three-dimensional articles having shapes other than sheet shapes, such as spherical or rectangular parallelepiped shapes, may also be used.

The articles to be dyed may be, for example, glass, metal, and ceramics, in addition to those formed from resins or plastics. Exemplary fibers that form a fabric as an article to be dyed include polyester fibers, nylon fibers, triacetate fibers, diacetate fibers, polyamide fibers, and blended fibers of two or more these fibers. In addition, blended fibers of these fibers with regenerated fibers, such as rayon, or with natural fibers, such as cotton, silk, and wool, may also be used.

Exemplary resin films as the article to be dyed include polyester films, polyurethane films, polycarbonate films, polyphenylene sulfide films, polyimide films, and polyamideimide films. These resin films may be layered bodies of a plurality of layers or may be formed from graded materials with gradual changes in material composition.

According to the foregoing manufacturing method for a dyed article, since the ink composition of the present embodiment is used, hue and coloring properties are excellent and weatherability of the dyed article can be enhanced.

Recording media including fabrics may be untreated fabrics but are preferably fabrics pretreated with a pretreatment solution containing resin particles. By pretreating fabrics, dyed articles having further excellent rubbing fastness are readily obtained.

### EXAMPLES

Hereinafter, the present disclosure will be described more specifically with reference to the Examples and Comparative Examples. The present disclosure, however, is by no means limited by the following Examples.

### Preparation of Ink Jet Ink Compositions

Each ink jet ink composition was obtained by mixing the respective materials in the composition shown in Tables 1 to 4 below and thoroughly stirring the resulting mixture. In Tables 1 to 4 below, the unit of the numerical values is % by mass and their total is 100.0% by mass. The respective contents of the disperse dyes and the resins are solids content-based values. Among the materials shown in Tables 1 to 4 below, Disperse Blue 359, Disperse Blue 60, and Disperse Blue 72 are disperse dyes having an anthraquinone skeleton, whereas Disperse Yellow 54 is a disperse dye having a quinoline skeleton.

TABLE 1

| Material | Example 1 | Example 2 | Example 3 | Example 4 | Example 5 |
|---|---|---|---|---|---|
| Disperse Blue 359 (DB359) | 2.4 | 3.2 | 1.6 | 4 | 0.8 |
| Disperse Blue 60 (DB60) | 2.4 | 1.6 | 3.2 | 0.8 | 4 |
| Disperse Blue 72 | — | — | — | — | — |
| Disperse Yellow 54 | — | — | — | — | — |
| Naphthalenesulfonate- | 4.8 | 4.8 | 4.8 | 4.8 | 4.8 |
| formaldehyde condensate | | | | | |
| (Demol NL) | | | | | |
| Styrene-acrylic resin | — | — | — | — | — |
| (Solsperse 43000) | | | | | |
| Urethane resin | — | — | — | — | — |
| (Solsperse 47000) | | | | | |
| Glycerol | 15.0 | 15.0 | 7.0 | 15.0 | 15.0 |
| Propylene glycol | 7.0 | 7.0 | 13.0 | 7.0 | 7.0 |
| Methyl triglycol | 3 | 3 | 3 | 3 | 3 |
| Surfactant (BYK 348) | 1 | 1 | 1 | 1 | 1 |
| Pure water | balance | balance | balance | balance | balance |
| OD value | A | A | A | A | B |
| Hue | A | A | A | B | A |
| Clogging test | A | A | A | A | A |
| Odor | B | B | B | B | B |
| Weatherability | A | A | A | B | A |
| Colorant concentration | 4.8 | 4.8 | 4.8 | 4.8 | 4.8 |
| Colorant ratio (DB60/DB359) | 1.0 | 0.5 | 2.0 | 0.2 | 5.0 |

TABLE 2

| | Example | Example | Example | Example | Example | Example |
|---|---|---|---|---|---|---|
| Material | 6 | 7 | 8 | 9 | 10 | 11 |
| Disperse Blue 359 (DB359) | 2.4 | 3.2 | 4 | 1.5 | 2.4 | 2.4 |
| Disperse Blue 60 (DB60) | 2.4 | 1.6 | 4 | 1.5 | 2.4 | 2.4 |
| Disperse Blue 72 | — | — | — | — | — | — |
| Disperse Yellow 54 | — | — | — | — | — | — |
| Naphthalenesulfonate-formaldehyde | — | — | 8 | 3 | 2.4 | — |
| condensate (Demol NL) | | | | | | |
| Styrene-acrylic resin (Solsperse 43000) | 4.8 | 4.8 | — | — | 2.4 | — |
| Urethane resin (Solsperse 47000) | — | — | — | — | 4.8 | |
| Glycerol | 15.0 | 15.0 | 15.0 | 15.0 | 15.0 | 15.0 |
| Propylene glycol | 7.0 | 7.0 | 7.0 | 7.0 | 7.0 | 7.0 |
| Methyl triglycol | 3 | 3 | 3 | 3 | 3 | 3 |
| Surfactant (BYK 348) | 1 | 1 | 1 | 1 | 1 | 1 |
| Pure water | balance | balance | balance | balance | balance | balance |
| OD value | A | A | A | B | A | A |
| Hue | A | A | A | A | A | A |
| Clogging test | A | A | B | A | A | B |
| Odor | A | A | B | B | A | A |
| Weatherability | A | A | A | A | A | A |
| Colorant concentration | 4.8 | 4.8 | 8 | 3 | 4.8 | 4.8 |
| Colorant ratio (DB60/DB359) | 1.0 | 0.5 | 1.0 | 1.0 | 1.0 | 1.0 |

TABLE 3

| | Comparative | Comparative | Comparative | Comparative | Comparative |
|---|---|---|---|---|---|
| Material | Example 1 | Example 2 | Example 3 | Example 4 | Example 5 |
| Disperse Blue 359 (DB359) | 4 | 2.4 | 4.8 | — | — |
| Disperse Blue 60 (DB60) | — | — | — | 4.8 | — |
| Disperse Blue 72 | — | 2.4 | — | — | 4.8 |
| Disperse Yellow 54 | 0.8 | — | — | — | — |
| Naphthalenesulfonate- | 4.8 | 4.8 | 4.8 | 4.8 | 4.8 |
| formaldehyde condensate | | | | | |
| (Demol NL) | | | | | |
| Styrene-acrylic resin | — | — | — | — | — |
| (Solsperse 43000) | | | | | |
| Glycerol | 7.0 | 15.0 | 15.0 | 15.0 | 15.0 |
| Propylene glycol | 7.0 | 7.0 | 7.0 | 7.0 | 7.0 |
| Methyl triglycol | 3 | 3 | 3 | 3 | 3 |
| Surfactant (BYK 348) | 1 | 1 | 1 | 1 | 1 |
| Pure water | balance | balance | balance | balance | balance |
| OD value | A | A | A | C | B |
| Hue | C | C | C | A | C |
| Clogging test | B | A | B | A | A |
| Odor | B | B | B | B | B |
| Weatherability | B | B | C | A | A |
| Colorant concentration | 4.8 | 4.8 | 4.8 | 4.8 | 4.8 |
| Colorant ratio (DB60/DB359) | — | — | — | — | — |

TABLE 4

| | Comparative | Comparative | Comparative |
|---|---|---|---|
| Material | Example 6 | Example 7 | Example 8 |
| Disperse Blue 359 (DB359) | 4.8 | 3.2 | 2.4 |
| Disperse Blue 60 (DB60) | — | — | — |
| Disperse Blue 72 | — | — | — |
| Disperse Yellow 54 | — | 1.6 | — |
| Naphthalenesulfonate- | — | — | — |
| formaldehyde condensate | | | |
| (Demol NL) | | | |
| Styrene-acrylic resin | 4.8 | 4.8 | 2.4 |
| (Solsperse 43000) | | | |
| Glycerol | 15.0 | 15.0 | 15.0 |
| Propylene glycol | 7.0 | 7.0 | 7.0 |
| Methyl triglycol | 3 | 3 | 3 |
| Surfactant (BYK 348) | 1 | 1 | 1 |
| Pure water | balance | balance | balance |
| OD value | A | A | C |
| Hue | C | C | C |
| Clogging test | C | C | B |
| Odor | A | A | A |
| Weatherability | C | B | B |
| Colorant concentration | 4.8 | 4.8 | 2.4 |
| Colorant ratio (DB60/DB359) | — | — | — |

The head of an ink jet printer (PX-G930, from Seiko Epson Corporation) was filled with each ink composition and confirmed that recording can be performed as usual without clogged nozzles. The above-mentioned each ink composition was discharged by using this ink jet printer to attach a 10-gradation pattern at recording resolution of 1440×720 dpi onto a DS Transfer Multipurpose intermediate transfer medium (from Seiko Epson Corporation). Here, the operation environment of the printer was set to 25° C.

Subsequently, the ink composition-attached side of the intermediate transfer medium was stuck on a fabric (polyester 100%, Amina, from Toray Industries, Inc.) as a white recording medium, and the ink composition was sublimation-transferred through heating with a heat press (TP-608M, from Taiyoseiki Co., Ltd.) under conditions of 200° C. for 60 seconds to yield each dyed article.

### Hue and Coloring Properties

For the obtained dyed articles, a* and b* defined in the CIELAB color space were measured in each gradation portion of a dyed region on the side that faced the intermediate transfer medium by using a colorimeter (Gretag Macbeth Spectrolino, from X-Rite Inc.), and the hue angle ∠H° and OD value were obtained and evaluated in accordance with the following criteria. The hue angle ∠H° is obtained from ∠H°=tan⁻¹(b*/a*)+180 (when a*<0) or ∠H°=tan⁻¹(b*/a*)+360 (when a*>0).

### Hue

A: hue angle ∠H° of 200° or more and less than 250°

B: hue angle ∠H° of 180° or more and less than 200°

C: hue angle ∠H° of less than 180°

### OD Values

A: OD value of 1.3 or more

B: OD value of 1.1 or more and less than 1.3

C: OD value of less than 1.1

### Weatherability

The obtained dyed articles were tested in accordance with ISO 105 B02, and the results were evaluated in accordance with the following criteria.

A: weatherability of grade 5 or higher

B: weatherability of grade 4 or higher and lower than grade 5

C: weatherability of grade 3 or higher and lower than grade 4

Recovery from Clogging after Unused State

The head of an ink jet printer (PX-G930, from Seiko Epson Corporation) was filled with each ink composition and confirmed that recording can be performed as usual without clogged nozzles. After normal discharge of all the nozzles was confirmed, the recording apparatus was turned off in the normal state and left in the environment of 40° C. for 1 month. The number of recovery operations by simultaneous suction of all the colors required for each color to achieve normal discharge was counted, and the result was evaluated in accordance with the following criteria.

A: all the colors were normalized by 5 or less recovery operations

B: all the colors were normalized 6 or more and less than 10 recovery operations

C: all the colors were not normalized even after 10 or more recovery operations

### Odor

All head rows of an ink jet printer (PX-G930, from Seiko Epson Corporation) were filled with each ink composition, and normal discharge was confirmed for all the rows. Subsequently, printing was performed in a closed room (height 3 m×width 5 m×5 m) for 1 hour. Inspectors then entered the room and assessed as follows. The assessment made by the majority of five inspectors was adopted.

A: barely perceived odor

B: odor of easily perceived identity

From the results of the Examples and Comparative Examples, it was found that hue and coloring properties can be enhanced in a well-balanced manner by combining C.I. Disperse Blue 359 and C.I. Disperse Blue 60. From the results of Examples 1 to 5, it was found that when a mass ratio of the content of C.I. Disperse Blue 60 to the content of C.I. Disperse Blue 359 is large, especially 0.2 or more, weatherability and hue tend to become further excellent. Meanwhile, it was also found that when the mass ratio of the content of C.I. Disperse Blue 60 to the content of C.I. Disperse Blue 359 is small and 5.0 or less, coloring properties tend to become further excellent. From the results of Examples 1, 6, and 11, it was found that odor is reduced by using a styrene-acrylic resin or a urethane resin as a dispersant, and clogging resistance tends to become further excellent when a styrene-acrylic resin is used.

What is claimed is:

1. A sublimation-transfer ink jet ink composition comprising
C.I. Disperse Blue 359 and
C.I. Disperse Blue 60.

2. The sublimation-transfer ink jet ink composition according to claim 1, wherein
a mass ratio of a content of C.I. Disperse Blue 60 to a content of C.I. Disperse Blue 359 is 0.2 to 5.0.

3. The sublimation-transfer ink jet ink composition according to claim 1, further comprising one or more dispersants, wherein
the dispersants include sodium naphthalenesulfonate-formaldehyde condensate.

4. The sublimation-transfer ink jet ink composition according to claim 1, further comprising one or more dispersants, wherein
the dispersants include a resin.

5. The sublimation-transfer ink jet ink composition according to claim 4, wherein
the resin is a styrene-acrylic resin.

6. The sublimation-transfer ink jet ink composition according to claim 3, wherein
a content of the dispersants is 3 to 8% by mass based on the total sublimation-transfer ink jet ink composition.

7. The sublimation-transfer ink jet ink composition according to claim 1, wherein
a total content of C.I. Disperse Blue 359 and C.I. Disperse Blue 60 is 3 to 8% by mass based on the total sublimation-transfer ink jet ink composition.

8. A manufacturing method for a dyed article, comprising:
discharging the sublimation-transfer ink jet ink composition according to claim 1 from a recording head to attach the ink composition to an intermediate transfer medium; and
transferring the sublimation-transfer ink jet ink composition attached to the intermediate transfer medium to a fabric, thereby obtaining the dyed article.
